(19) United States
(12) Patent Application Publication
(10) Pub. No.: US 2016/0186017 A1
(43) Pub. Date: Jun. 30, 2016

(54) Anisotropic Conductive Adhesive

(71) Applicant: Allen Howard Engel, Auburn, WA (US)

(72) Inventor: Allen Howard Engel, Auburn, WA (US)

(21) Appl. No.: 14/586,653

(22) Filed: Dec. 30, 2014

(51) Int. Cl. C09J 9/02; C08K 7/14; C08K 3/40

(52) U.S. Cl. CPC C09J 9/02; C08K 3/40; C08K 7/14; C09J 2433/003; C09J 2479/023

(57) ABSTRACT

An anisotropic conductive adhesive comprised of electrically conductive polymer particles that has a wide temperature usage range, resists corrosion, and is compressible to increase the surface area of the conductive polymer particles in contact with nearby electrical components. In some embodiments the adhesive is transparent or semi-transparent, enabling visible light inspection and ultraviolet light curing. The conductive polymer particles are available in particle size ranges with much smaller diameters than prior art inorganic conductive particles, enabling denser pitches.

### BACKGROUND

### Prior Art

The following is a tabulation of some prior art that presently appears relevant:

U.S. Patents

| Patent Number | Issue Date | Patentee |
|---|---|---|
| 4,113,981 | 1978 Sep. 12 | Fujita, et al. |
| 5,686,703 | 1997 Nov. 11 | Yamaguchi, Hiroaki |
| 5,840,215 | 1998 Nov. 24 | Iyer, Shridhar |
| 6,039,896 | 2000 Mar. 21 | Kawata, Masakaza |
| 6,255,585 | 2001 Jul. 3 | Jones, Mark R. |
| 6,422,982 | 2002 Aug. 6 | Wang, et al. |
| 6,827,880 | 2004 Dec. 7 | Ishimatus, Tomoyuki |
| 7,005,731 | 2006 Feb. 28 | Jiang, Tongbi |
| 7,026,239 | 2006 Apr. 11 | Souriau, Jean-Charles |
| 7,026,436 | 2006 Apr. 11 | Kanakarajan, Kuppusamy |
| 7,736,541 | 2010 Jun. 15 | Toshioka, Hideaki |

Foreign Patents

| | Country | | |
|---|---|---|---|
| Patent Number | Code | Issue Date | Patentee |
| EP0265077A2 | US | Mar. 8, 1989 | Gilleo, Kenneth B. |
| EP 1832636A1 | US | Sep. 12, 2007 | Chang, Chih-Min |

### PUBLICATIONS

http://www.specialchem4coatings.com/tc/hyperdispersants/index.aspx?id=coating
Yang, et al., Journal of Polymer Science Part B: Polymer Physics, Vol. 40, 2702-2713 (2002)
“Polyaniline Emaraldine Base in N-Methyl-2-pyrrolidinone Containing Secondary Amine Additives: A Rheological Investigation of Solutions”
Polyaniline Doped with Sulphosalicylic, Salicylic and Citric Acid in Solution and Solid-state, Ghadimi, et al., Iranian Polymer Journal; 11, 2; 159-166, 2002
Electrically Conductive Polyaniline Adhesive, Makela, et al., VTT Microelectronics, Espoo, 02/2000; DOI:10.1109/ADHES.2000.860584 ISBN: 0-7803-6460-0 In proceeding of: Adhesive Joining and Coating Technology in Electronics Manufacturing, 2000.

Anisotropic conductive adhesives (a.k.a. Z-axis adhesives) are used in a variety of electronic applications; the adhesion of flexible printed circuit boards to rigid printed circuit board substrates, tape automated bonding integrated circuits to glass or liquid crystal displays, and flip chip on various substrates such as glass panels and glass fiber-reinforced epoxy printed circuit boards. For instance, a conventional flip chip package typically consists of a bare semiconductor device that is solder-bumped on the conductive pads on its surface, turned upside down to face the substrate that has corresponding conductive pads with solder; the solder on the substrate is flowed to form an electrically conductive bond between the pads on the device and the substrate; and finally an encapsulant (insulating) is flowed between the two to protect the device against the environment and improve fatigue life performance. If an anisotropic conductive adhesive is used, it circumvents the practice of solder bumping the device, an expensive step in the flip chip manufacturing process. The conductive particles in the adhesive make the electrically conductive connection between the pads on the device and the substrate while preserving its insulating properties in the transverse direction.

When connecting an electronic component (e.g., an integrated circuit (IC) chip) to a circuit substrate (e.g., a tape automated bonding (TAB) tape), it is desirable to use an anisotropic, electrically conductive adhesive that provides both excellent adhesion and a highly reliable electrical connection.

Anisotropic conductive adhesives are adhesives that are comprised of electrically conductive particles at a concentration below that of an isotropic material. The concentration is controlled such that the adhesive is conductive in one direction only and is an electrical insulator in the transverse direction. U.S. Pat. No. 4,113,981 Fujita, et al. Sep. 12, 1978 describes the art of using conductive particles to make such an adhesive. The conductive particles are usually spherical or substantially spherical in shape and can be metal particles made of metals such as silver, nickel and gold, or they can be plated insulating materials such as coated polymer powder or glass beads. The particle size distribution and volume content of the particles is tightly controlled to achieve electrical conductivity in only one direction.

In general, anisotropic, electrically conductive adhesives comprise electrically conductive particles dispersed in an electrically insulating adhesive. A highly reliable electrical connection is achieved by providing a stable electrical resistance; that is, an electrical resistance that changes only minimally upon use and aging of the adhesive. Toward this goal, it is important to firmly fix the conductive particles between the electronic component and the circuit substrate with the insulating adhesive because physical shifting of the conductive particles can cause the electrical resistance to change.

Unfortunately, however, the difference between the thermal expansion coefficients of the conductive particles and the insulating adhesive is quite substantial. Usually the thermal expansion coefficient of the adhesive is larger than that of the conductive particles. As a result, temperature changes normally experienced by electronic component assemblies that incorporate anisotropic, electrically conductive adhesives can cause the insulating adhesive and the conductive particles to expand and contract at different rates. The forces exerted on the particles by the expansion and contraction of the adhesive may result in physical shifting of the conductive particles, which is undesirable.

In addition, anisotropic, electrically conductive adhesives should, preferably, be transparent so that the electronic component can be properly aligned or registered with the circuit substrate when they are bonded together during manufacture.

Since the adhesive is transparent, it can be quickly polymerized with uv light. Many prior art adhesives incorporate metal particles, and hence are not transparent.

There is a strong demand for an anisotropic conductive adhesive that can cure in a short time and has excellent adhesive properties, bonding reliability, storage stability, repair properties and the like.

Ideally z axis adhesives enable relatively imprecise location of the placement of the electronic device onto another electronic device. Since the z axis adhesive accommodates imprecise placement, the electronics assembly production line can run at higher speeds. In addition, since the z axis adhesive is tolerant of relatively imprecise placement, the adhesive can be used with high speed pick and place equipment which is used in packaging or printing applications. For example, 2 axis linear actuators can place more than 100 electronic components per minute. As such z axis adhesives enable the use of roll to roll printing equipment for the handling of a flexible circuit board assembly.

Prior art z axis adhesives and z axis films have many characteristics that make them less than optimum for roll to roll equipment.

Z axis adhesives often incorporate metal particles or metal-clad particles as conductors. Metals have limited compatibility with common polymer adhesives. In addition, metals have substantially different heat coefficients of expansion from common polymer adhesives.

Metals are affected by corrosion, including galvanic corrosion.

Metals are not compressible without applying significant forces, forces which are not typical for a printing production line. It is not facile to increase the surface contact of a metal particle with the top or bottom adherents by compressing the metal particle between the adherents. The metal particle surface has too high a durometer to be easily compressed.

Prior art z-axis adhesives typically incorporate thermoplastic adhesive polymers or thermoset adhesive polymers.

Thermoplastic adhesive polymers become tacky at temperatures above 160 F, which is well above ambient. It takes time for the thermoplastic adhesive to become tacky, which slows the production line.

Thermoset adhesive polymers require significant dwell time for the polymer catalyst to act within the adhesive bond to make the bond permanent. This long dwell time also slows the production line.

The thermoplastic adhesive polymers, and the thermoset adhesive polymer mixtures are often not solid state, and hence solvents are commonly used to compatibilize the polymers and metal particles of the z axis adhesive.

The conductive metal particles are not transparent, so visual inspection of the bond is not possible. Metal bearing adhesives usually have limited transparency to ultraviolet radiation, which makes ultraviolet curing difficult.

The conductive particles often have complex and costly geometries. In order to achieve a compressible conductive particle, some patents teach a hollow polymer sphere particle, coated by a metallic skin.

Normally metal particles are available in a limited range of micron sizes. It is common for the data sheets for prior art z axis adhesives to describe the particles size ranges as 1-3 microns, or 3-7 microns, or larger. These relatively tight distribution of particle sizes restricts the pitch of the z axis adhesive to a relatively narrow range of pitches. As electrons devices shrink in size, it is necessary for the pitch of device interconnects to become denser and thinner.

### Advantages

Accordingly several advantages of one or more aspects are as follows: the thermal expansion coefficient of the conductive particle and the adhesive should be similar, the adhesive should resist corrosion, the adhesive mixture should be transparent or semitransparent to allow for fast printing, ultraviolet curing and in-line inspection of the connection, the conductive particles should have a durometer that allows the conductive particle to compress and increase its surface contact with the other electronic components, and the particles would be available in a wide variety of sizes, including very small diameters, to enable denser pitches.

Other advantages of one or more aspects will be apparent from a consideration of the drawings and ensuing description.

### DRAWINGS

### Figures

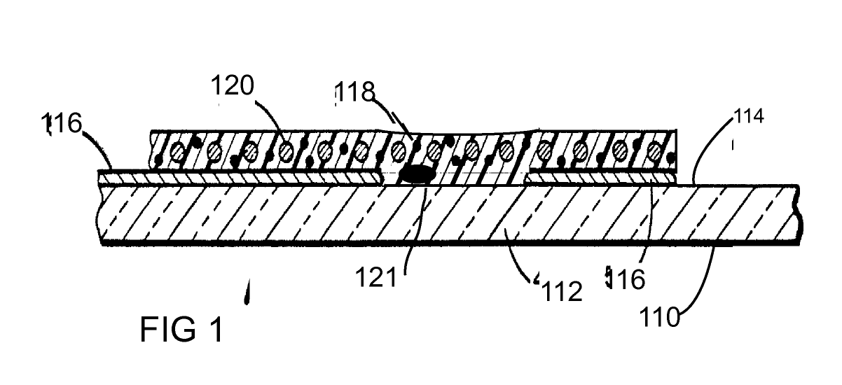

FIG. 1 shows the anisotropic adhesive and optional spacers printed onto the electrodes and the substrate.

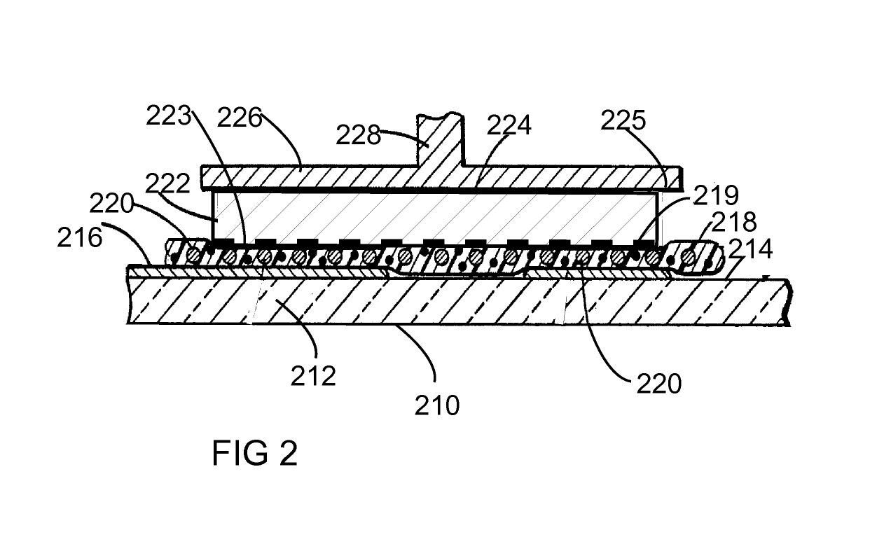

FIG. 2 shows a semiconductor and its pads in direct contact with the anisotropic adhesive, and the adhesive and optional spacers printed onto the electrodes and the substrate.

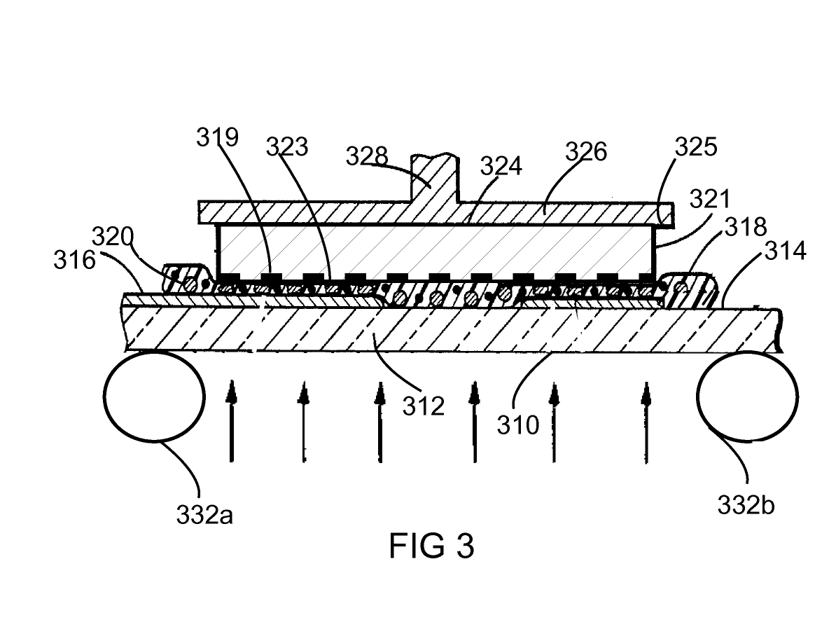

FIG. 3 shows a semiconductor and its pads in direct contact with the anisotropic adhesive, and the adhesive and optional spacers printed onto the electrodes and the substrate. Rollers support the substrate. A platen compresses the semiconductor into the adhesive. Ultraviolet radiation polymerizes the free radical curing resins within the adhesive mixture.

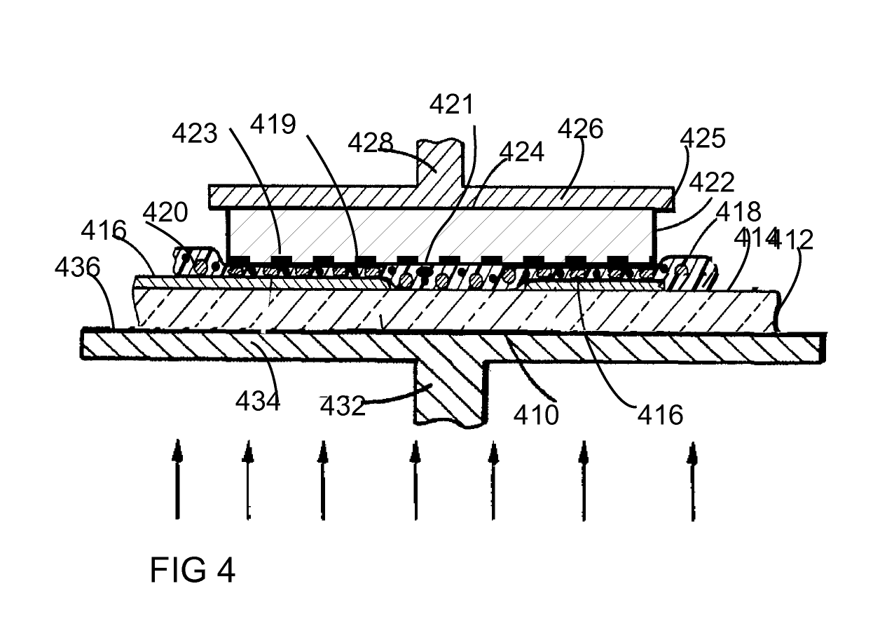

FIG. 4 shows a semiconductor and its pads in direct contact with the anisotropic adhesive, and the adhesive and optional spacers printed onto the electrodes and the substrate. A platen compresses the semiconductor into the adhesive. Another platen supports the substrate. Ultraviolet radiation polymerizes the free radical curing resins within the adhesive mixture.

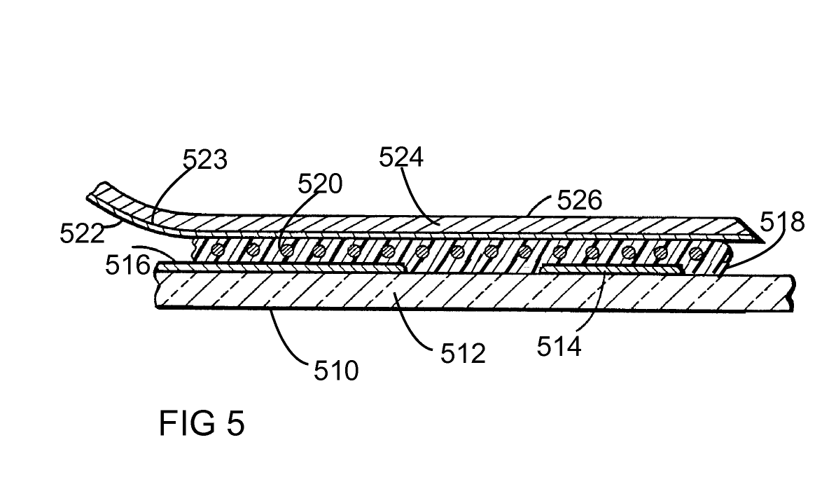

FIG. 5 shows a lamination comprised of two substrates, each substrate having electrodes on its inside surface. A conductive anisotropic adhesive and optional spacers are deposited between the substrates, forming a conductive bond between the conductive electrodes of the substrates.

Referring to FIG. 1, a plastic film sheet or continuous web or flexible substrate 112 has a bottom surface 110, and a top surface 114. On the top surface 114 are conductive patterned plastic electrodes, or conductive patterned metal electrodes, or conductive patterned electrodes comprised of a plurality of metal particles and polymer 116. Printed onto both the electrodes 116 and the top surface 114 of the plastic film sheet 112 is the anisotropic adhesive 118. Dispersed within the anisotropic adhesive 118 are a plurality of conductive particles 120 and optionally spacers 121.

Referring to FIG. 2, a plastic film sheet or continuous web or flexible substrate 212 has a bottom surface 210, and a top surface 214. On the top surface 214 are conductive patterned plastic electrodes, or conductive patterned metal electrodes, or conductive patterned electrodes comprised of a plurality of metal particles and polymer 216. Printed onto both the electrodes 216 and the top surface 214 of the plastic film sheet 212 is the anisotropic adhesive 218. Dispersed within the anisotropic adhesive 218 are a plurality of conductive particles 220 and optionally spacers 221. The semiconductor 222 has a bottom surface 223 with a plurality of semiconductor pads 219. The semiconductor 222 has a top surface 224 which is in contact with the bottom surface 225 of a pressure platten 226. The pressure platten 226 has an arm 228 actuated by a means to compress the arm (not shown)

Referring to FIG. 3, a transparent plastic film sheet or continuous web or flexible substrate 312 has a bottom surface 310, and a top surface 314. On the top surface 314 are conductive patterned plastic electrodes, or conductive patterned metal electrodes, or conductive patterned electrodes comprised of a plurality of metal particles and polymer 316. Printed onto both the electrodes 316 and the top surface 314 of the plastic film sheet 312 is the anisotropic adhesive 318. Dispersed within the anisotropic adhesive 318 are a plurality of conductive particles 320 and optionally spacers 321. The semiconductor 322 has a bottom surface 323 with a plurality of semiconductor pads. 319. The semiconductor 322 has a top surface 324 which is in contact with the bottom surface 325 of pressure platten 326. The pressure platten 326 has an arm 328 which is actuated by a means to actuate the arm 328 (not shown). Rollers 332a and 332b support the plastic film web 312. UV light radiates through the transparent film sheet 312 and causes some of the monomers in the anisotropic adhesive 318 to crosslink tightly, causing the volume of the adhesive 318 to shrink and pull the top surface 314 of plastic film 312 to the bottom surface 323 and semiconductor pads 319 of semiconductor 322.

Referring to FIG. 4, a transparent plastic film sheet or continuous web or flexible substrate 412 has a bottom surface 410, and a top surface 414. On the top surface 414 are conductive patterned plastic electrodes, or conductive patterned metal electrodes, or conductive patterned electrodes comprised of a plurality of metal particles and polymer 416. Printed onto both the electrode 416 and the top surface 414 of the plastic film sheet 412 is the anisotropic adhesive 418. Dispersed within the anisotropic adhesive 418 are a plurality of conductive particles 420 and optionally, spacers 421. The semiconductor 422 has a bottom surface 423 with a plurality of semiconductor pads 419. The semiconductor 421 has a top surface 424 which is in contact with the bottom surface 425 of pressure platten 426. The pressure platten 426 has an arm 428 that connects to a placement machine (not shown). The bottom surface 410 of the plastic film 412 is in contact with the top surface 436 of the transparent counter platen 434. An arm 432 connects the counter platten 434 with the placement machine. UV light radiates through the transparent pressure platten 434 and through the transparent film sheet 412 and causes some of the monomers in the anisotropic adhesive 418 to crosslink tightly, causing the volume of the adhesive 418 to shrink and pull top surface 414 of the plastic film 412 to the bottom surface 423 and semiconductor pads 419 of semiconductor 422.

Referring to FIG. 5, a plastic film sheet or continuous web or bottom substrate 512 has a bottom surface 510, and a top surface 514. On the top surface 514 are conductive patterned plastic electrodes, or conductive patterned metal electrodes, or conductive patterned electrodes comprised of a plurality of metal particles and polymer 516. Printed onto both the electrodes 516 and the top surface 514 of the substrate 512 is the anisotropic adhesive 518. Dispersed within the anisotropic adhesive 518 are a plurality of conductive particles 520. The bottom surface 523 of the top substrate 524 and the conductive patterned electrodes 522 adhere to the anisotropic adhesive 518. The top substrate 524 has a top surface 526.

Here is an outline of how Example 4 functions:

The anisotropic adhesive 418 is printed onto the substrate 412.

A semiconductor 422 is placed onto the adhesive 418. Optionally spacers maintain the parallel orientation of the semiconductor 422 and the substrate 412.

A platen 426 actuated by a means to move the platen (not shown) applies pressure to the top of the semiconductor 422. Alternately another platen 434, which is transparent to radiation, is also actuated by a means to move the platen 434 (not shown) and applies pressure against the outside surface of the substrate 412

The adhesive 418 is compressed by a platen 426 or platen 434 compressing the semiconductor 422 and/or the substrate 412. The anisotropic conductive adhesive 418 has a predetermined viscosity and under compression flows to intimate contact with the semiconductor 422 and the flexible substrate 412. Optionally spacers 421 within the adhesive 418 maintain the optimum gap between the semiconductor 422 and the substrate 418, and maintain the parallel planar orientation between the semiconductor 422 and the substrate 412. The adhesive 418 mixture is then polymerized by radiation, usually ultraviolet radiation. Thus the conductive adhesive 418 provide an electrically conductive interface between the semiconductor component 422 and the electrodes 416 of the substrate 412, respectively. In some embodiments the free radical curing polymers polymerize dense and shrink the volume of the adhesive, causing the adhesive 418 mixture to pull the semiconductor 422 and the substrate 412 more closely together.

The means to move the platen or platens are actuated and then the platens are removed from contact with their respective substrates.

It is very efficient to use ultraviolet light emitting diodes to polymerize the adhesive 418.

Here is a list of exemplary high shrinkage polymers:

SR285, tetrahydrofurfuryl acrylate, 18% shrinkage
SR238,1,6 hexanediol diacrylate, 22% shrinkage
SR306, tripropyleneglycol diacrylate, 17% shrinkage
SR344, polyethyleneglycol diacrylate, 10% shrinkage
SR9003, propoxylated neopentylglycol diacrylate, 16% shrinkage
SR351, trimethylolpropane triacrylate, 28% shrinkage
SR454, ethoxylated trimethylolpropane triacrylate, 19% shrinkage
SR295, pentaerythritol tetaacrylate, 33% shrinkage

Many forms of polyaniline are transparent. By using transparent plastic or polymer in the lead frame structure, ultraviolet (UV), or other light source, cure of the die attach material becomes possible. This is particularly advantageous in an automated production environment. Furthermore, both of the lead frame embodiments are nonmetallic and thus less susceptible to corrosion or oxidation.

A z axis adhesive comprising conductive polymer particles, and thermoplastic adhesives or free radical adhesives or cationic cure adhesives, solves many of the shortcomings described above.

This novel adhesive would be comprised of conductive polymer particles, tackifier or tackifier-plasticizer or adhesive polymer, optional solvent, and optional hyperdispersant. The conductive polymer particles would ideally have a relatively tight distribution of particle sizes.

As a polymer, the general characteristics of conductive polymers more closely match the characteristics of common adhesive polymers, in particular, having a similar heat coefficient of expansion.

The surface durometer of the conductive polymer particles is much softer than common metal particles. The overall durometer of the conductive polymer particle is substantially lower than a metal particle. The softer durometer of the conductive polymer particle allows the particle to be compressed between the two electronic devices being assembled. Compression of the particle increases its surface area contact between the particle and the electronic devices, increasing the conductivity of the connection.

Since the particle is compressible, it can also decompress and resume its intimate contact between the two electronic devices. The tackifier-plasticizer in the adhesive mixture increases the compressibility of the conductive polymer particle.

To function as an adhesive in the x axis, y axis, and the z axis, the percentage of polyaniline would be much greater, to achieve the minimum percolation threshold percentage of the conductive adhesive. Since the adhesive is mostly comprised of transparent polymers & tackifiers, and since polyanline particles are not completely opaque, free radical curing acrylates, polyurethanes, and cationic cure acrylic epoxies can comprise the mixture.

Specialchem4coatings.com describes hyperdispersants: “Hyperdispersants differentiate themselves from standard dispersing agents through considerably higher molecular weights and optimum long term storage stability. Compared to the latter, they allow low foaming (especially in waterborne systems), improved pigment stability and a significant increase in tinctorial properties.” (Hyperdispersants aka) “Polymeric dispersants have been specifically developed to help to overcome some of the problems posed by changes in technology due to their ability to successfully wet and stabilize pigment and reduce the effect of the dispersed pigment on the rheology of the finished paint or ink.”

Many of the possible embodiments benefit from the incorporation of small amounts of hyperdispersants in the mixture.

Spacers maintain the planarity of the filled gap between the top substrate and the bottom substrate. Common spacers for lcd displays are glass fibers, glass balls, polymer fibers, polymer balls, and others.

UV curing means that the adhesives gel quickly and polymerize quickly, much faster than most thermoplastic adhesives or thermoset adhesives. The fast cure times with uv curing adhesives allows much faster production speeds.

UV curing enables controlled shrinkage of the adhesive connection. Shrinkage causes compressive forces in all directions, that can draw and compress the polyaniline particle so that the surface area of the particle in direct contact with the electronic components is enlarged. Doing so improves the electrical characteristics of the adhesive connection.

Other forms of curing are electron beam radiation, cationic curing polymers, and laser curing polymers.

Inline inspection by a visual means is possible since the adhesive is transparent or semi-transparent.

Some ultraviolet curing polymers have very low viscosities, as do some tackifiers. In some embodiments the adhesive has a viscosity and thixotropy that can be printed by flexographic printing equipment, even though the viscosity of the adhesive is much higher than many flexographic inks. So in some embodiments, diluent solvents are not necessary.

Since the adhesive mixture is comprised of ordinary tackifiers or tackifier-plasticizers, or uv curing polymer adhesives, high curing temperatures are not necessary. Since the adhesives can be handled in room temperatures, ordinary printing equipment can be used. Using these new z axis adhesives at ambient temperatures is comfortable for assembly workers.

Large amounts of solvents are not necessary to compatibilize the polyaniline particles with the polymer ingredients. 100% solids thermoplastic pressure sensitive adhesives are possible, as well as uv curing adhesives are possible. The very low viscosity uv curing polymer diluent functions like a solvent for the mixture, as does the tackifier.

The polyaniline particles are commonly polymerized in a wide variety of submicron and micron diameters. The particles can be segregated into specific size ranges by centrifuging, filtering, and the like. The wide variety of polyaniline particle sizes means that the formulator can custom formulate the adhesive mixture to achieve optimized pitch by choosing the appropriate size polyaniline particles range.

Polyaniline and other conductive polymers are not affected by common types of metal corrosion.

In one embodiment, the component is attached to a substrate using the adhesive by the steps comprising:

(a) providing the flexible substrate;
(b) dispensing on a portion of the substrate an anisotropic conductive adhesive composition comprising polymer, and up to about 60% by volume of the anisotropic conductive adhesive composition of at least one electrically conductive material, and
(c) attaching the component (first surface containing the conductive pads) on the surface of the anisotropic conductive adhesive composition dispensed on the substrate while the adhesive is a liquid under conditions effective to provide electrically conductive paths between the conductive pads on the component and the substrate while maintaining an electrically insulating property in the transverse direction, thereby bonding the component to the substrate, and providing an assembly.

The size and material of these conductive particles may be selected as necessary depending on the pitch and pattern of the circuits to be connected, and the thickness and material, etc. of the circuit terminals.

Typically, the conductive particles are incorporated in an amount of about 0.5 to 20% by volume, preferably from 1 to 5% by volume, based on the entire volume of the anisotropic, electrically conductive adhesive.

A wide variety of other additives may be usefully incorporated into the insulating adhesives used in the invention such as tackifiers, antioxidants, surfactants, and the like, so long as they are employed in an amount that does not materially, adversely affect the performance properties of the anisotropic, electrically conductive adhesive.

The thickness of the anisotropic, electrically conductive adhesive coating depends on the intended application and the adherents (electronic components and circuit substrates) that are to be bonded together. The adhesive coating should not be so thin that it becomes difficult to fill the volumetric space between the electronic component and the circuit substrate. Nor should the adhesive coating be so thick that it can not readily accommodate electronic assemblies having a fine pitch.

For example, the insulating adhesive may be dissolved in a suitable solvent, and the conductive particles and the glass particles dispersed in the resulting solution. The order of addition of the conductive particles and the glass particles is not critical. They may be added sequentially in any order, or they may be added simultaneously. The resulting dispersion of glass and conductive particles in the insulating adhesive solution may be coated onto the substrate.

### Formulation Example 1

### Hercolyn D 2.9 g

### Rit AT25 1.85 g

### 11.8 g Toluene

### Polyaniline 2.25 g

### Formulation Example 2

20% 1 6 hexanediol diacrylate
20% 3,3,5-trimethylcyclohexane methacrylate
20% cyclohexyl methacrylate
5% uv initiator Lucirin TPO

### 22% Polyaniline

### 3% DBSA (Dodecylbenzylsulfonate)

10% alpha-pinene

What is claimed is:

1. An anisotropic, electrically conductive adhesive comprising an electrically insulating adhesive, electrically conductive polymer particles dispersed in the insulating adhesive, and compatible tackifiers.

2. The conductive particles of claim 1 are selected from the group comprising polyaniline particles, polyacetylene particles, polythiophene particles, polypyrrole particles, polyphenylene vinylene, and polyphenylene sulfide.

3. The tackifiers of claim 1 are selected from the group comprising alpha-pinene resins, Hercolyn D, Rit AT25, Piccotac 1020, Dercolyte A115, Uniplex 600, Sylvares TRA 25, Nevoxy G10, Neville XL, Riticizer 8, Abalyn, Staybelite Ester 3, Staybelite Ester 5, Staybelite Ester 10, Piccolyte, a-pinene resin, and Piccotac 1020.

4. The adhesive of claim 1, wherein said adhesive can be applied to a printed circuit board to form electrically conductive traces wherein said traces have a minimum width of 5 times the mean diameter of the conductive particles.

5. The conductive polymer particles of claim 1, wherein said particles have a means for resisting corrosion.

6. An anisotropic, electrically conductive adhesive of claim 1, wherein the ingredients comprising said adhesive have similar thermal expansion rates, whereby the adhesive has a working temperature range between −20 C and 80 C.

7. An anisotropic electrically conductive adhesive according to claim 1, further including spacers with a means for maintaining the gap between the adherents in contact with said adhesive.

8. An anisotropic electrically conductive adhesive according to claim 1, wherein the spacers are selected from the group comprising glass balls, polymer balls, glass fibers, or polymer fibers.

9. An anisotropic electrically conductive adhesive of claim 1, wherein the adhesive mixture is transparent or semi-transparent to ultraviolet radiation, electron beam radiation, and visible radiation.

10. An anisotropic electrically conductive adhesive of claim 1, wherein said adhesive mixture is transparent or semi transparent, whereby said adhesive can be inspected by a visual means.

11. An anisotropic electrically conductive adhesive of claim 1, wherein the adhesive is selected from the group comprising free radical curing polymers and photoinitiators, cationic curing polymers and photoinitiators, or near vis curing polymers and photoinitiators.

12. The anisotropic adhesive of claim 1, wherein the adhesive has a means for shrinking during crosslinking, whereby one adherent is pulled into closer to the other adherents, compressing the electrically conductive particles between said adherents.

13. The conductive polymer particles of claim 1, wherein said conductive polymer particles have a means to be compressed, thereby increasing the surface area of said conductive polymer particles in contact with adherents.
